(19) United States
(12) Patent Application Publication
(10) Pub. No.: US 2003/0069343 A1
(43) Pub. Date: Apr. 10, 2003

(54) Melt-processible poly(tetrafluoroethylene)

(76) Inventors: Paul Smith, Zurich (CH); Jeroen Visjager, Zurich (CH); Cees Bastiaansen, Maastricht (NL)

Correspondence Address: PILLSBURY WINTHROP, LLP, P.O. BOX 10500, MCLEAN, VA, 22102, US

(21) Appl. No.: 10/098,613

(22) Filed: Mar. 18, 2002

Related U.S. Application Data
(63) Continuation-in-part of application No. 09/505,279, filed on Feb. 16, 2000.
Application No. 09/505,279 is a continuation-in-part of application No. 09/369,319, filed on Aug. 6, 1999.
(60) Provisional application No. 60/095,583, filed on Aug. 6, 1998.

(51) Int. Cl. C08F 16/24; B29C 45/00

(52) U.S. Cl. 524/431; 526/247; 526/250; 526/253; 524/495; 264/328.1

(57) ABSTRACT

The present invention provides melt-processible poly(tetrafluoroethylene) polymers having a peak melting temperature above 315° C. and good mechanical properties at room temperature and at elevated temperatures, for instance a strain at break (25° C.) of at least 125% and a tensile strength (150° C.) of at least 7 MPa, both determined at a strain rate of 100/min.

### CROSS-REFERENCE TO RELATED APPLICATIONS

The present application is a Continuation-in-Part of U.S. application Ser. No 09/505,279, filed Feb. 16, 2000, which is itself a Continuation-in-Part of U.S. application Ser. No. 09/369,319, filed Aug. 6, 1999, which claims the benefit of U.S. Provisional Application No. 60/095,583, filed Aug. 6, 1998. All three prior applications are hereby incorporated in their entirety by reference.

### FIELD OF THE INVENTION

This invention relates to melt-processible poly(tetrafluoroethylene) (PTFE), compositions thereof, articles formed therefrom, and methods for making the same. More particularly, the present inventions relates to a particular range of poly(tetrafluoroethylene) polymers which are readily melt-processible while exhibiting good mechanical properties, both at room temperature and at elevated temperatures.

### BACKGROUND OF THE INVENTION

Poly(tetrafluoroethylene) (PTFE) is well-known for, among other properties, its chemical resistance and high temperature stability. As a result, it has found numerous applications in harsh physico-chemical environments and other demanding conditions. Equally well-known is the intractability of this important polymer. Numerous textbooks, research articles, product brochures and patents state that PTFE is intractable because, above its crystalline melting temperature, it does not form a fluid phase that is of a viscosity that permits standard melt-processing techniques commonly used for most thermoplastic polymers (Modern Fluoropolymers, J. Scheirs, Ed. Wiley (New York), 1997; The Encyclopedia of Advanced Materials, Vol. 2, D. Bloor et al. Eds., Pergamon (Oxford) 1994; WO 94/02547; WO 97/43102).

The above drawback of PTFE has been recognized virtually since its invention, and ever since, methods have been developed to circumvent the intractability of the polymer. For example, a variety of co-monomers have been introduced in the PTFE macromolecular chains that lead to co-polymers of reduced viscosity and melting temperature. Current commercial co-polymers (often referred to as FEP, MFA, PFA and Teflon® AF) provide improved processibility, and can be processed with techniques for common thermoplastic polymers (WO 98/58105). However, the high co-monomer content of these co-polymers leads to a penalty being paid in terms of some or all of the outstanding properties of the homopolymer PTFE, such as reduced melting temperature and thermal and chemical stability.

Recently, PCT Applications have been published that discuss melt-processible poly(tetrafluoroethylene) polymers having reduced co-monomer contents (WO 01/60911; WO 00/08071).

One of the objectives of the present invention is to provide melt-processible poly(tetrafluoroethylene) polymers having a high melting temperature and good mechanical properties both at room temperature and at elevated temperatures.

### SUMMARY OF THE INVENTION

The present invention provides melt-processible poly(tetrafluoroethylene) polymers having a peak melting temperature above 315° C. and good mechanical properties at room temperature and at elevated temperatures, for instance a strain at break (25° C.) of at least 125% and a tensile strength (150° C.) of at least 7 MPa, both determined at a strain rate of 100/min.

In one embodiment, the present invention provides a poly(tetrafluoroethylene) polymer having:

(i) a melt flow index (372° C.; 10 kg) of at least 0.1 g/10 min;

(ii) a strain at break at 25° C., as determined at a strain rate of 100/min, of at least 125%;

(iii) a tensile strength at 150° C., as determined at a strain rate of 100/min, of at least 7 MPa;

(iv) a co-monomer content below 2.2 wt %;

(v) a peak melting temperature above 315° C.;

(vi) a crystallinity below 60%; and

(vii) one or more of the following parameters:

(a) a peak melting temperature below 320° C.;

(b) a crystallinity between 30% and 54%;

(c) a melt-flow index (372° C./10 kg) below 10 g/10 min;

(d) a co-monomer content above 1 wt %.

The present invention further provides methods for processing the present poly(tetrafluoroethylene) polymers and articles comprising the present poly(tetrafluoroethylene) polymers.

### BRIEF DESCRIPTION OF THE DRAWINGS

FIG. 1 is a stress-strain curve of a melt-processed film of PTFE according to the present invention, compared to a prior art commercial, sintered and skived film of common (ultra-high molecular weight) PTFE, and a prior art pressed film of PFA 340.

### DETAILED DESCRIPTION OF THE INVENTION

Definitions and Preliminary Remarks

Void free—refers to a polymer or polymer composition, below its crystallization temperature, having a void content lower than sintered tetrafluoroethylene polymers including sintered tetrafluoroethylene polymers modified up to 0.1 wt % with PPVE (which are reported to have a void content of 2.6‰ or higher in the Modern Fluoropolymers, J. Scheirs, Ed. Wiley (New York 1997) at p. 253). Preferably, present polymers or polymer compositions, below their crystallization temperature, have a void content lower than 2‰, for instance below 1.5‰ or 0.75‰, as determined by measuring gravimetrically the (apparent) density of a specimen and the intrinsic density via its IR spectroscopically determined amorphous content (as discussed in the Modern Fluoropolymers, J. Scheirs, Ed. Wiley (New York 1997) at pp.240-255, in particular p. 253).

Monomeric units—refers to a portion of a polymer that corresponds to the monomer reactant used to form the polymer. For example, —CF₂CF₂— represents a monomeric unit derived from the monomer reactant tetrafluoroethylene.

The term PTFE grades as used herein refer to the fluoropolymer exclusive of the fillers and/or other components. It is understood and well-known that added matter, such as fillers, reinforcing matter, dyes, plasticizers and the like, may influence various material characteristics. The added matter, and the possible resulting effect on materials properties, however, are not to be considered in defining the particular set of properties of the melt-processible PTFE of the present invention.

The book “Modern Fluoropolymers”, J. Scheirs, Ed. Wiley (New York 1997) is hereby incorporated in its entirety by reference.

The strain rates referred to herein are initial strain rates (i.e. the drawing speed divided by the initial length of the sample).

The Poly(tetrafluoroethylene) Polymers

The PTFE's according to the present invention generally are polymers of tetrafluoroethylene. Within the scope of the present invention it is contemplated, however, that the PTFE may also comprise minor amounts of one or more co-monomers such as hexafluoropropylene, perfluoro(methyl vinyl ether), perfluoro(ethyl vinyl ether), perfluoro(propyl vinyl ether), perfluoro-(2,2-dimethyl-1,3-dioxole). Preferably, the amount of such co-monomer is below 2.2 wt %, such as below 2 wt %, 1.8 wt %, 1.6 wt %, or 1.4 wt %. In one embodiment of the invention, the co-monomer content is at least 0.05 wt %, for instance at least 0.2 wt %, at least 0.5 wt %, or even above 1 wt %, such as at least 1.1 wt % or at least 1.3 wt %.

Suitable polymers include those having a peak melting temperature, as measured under standard conditions, that is above 315° C., such as at least 315.5° C. or at least 316° C. Typically, the polymer will have a peak temperature below 330° C., such as below 325° C., below 322° C., below 320° C., or below 319° C. Preferably, the polymer has no peak melting temperature equal to or below 315° C.

In addition, suitable poly(tetrafluoroethylene)s according to the present invention include those having good mechanical properties at elevated temperatures, combined with a highly beneficial thermoplastic flow behavior. An indication of the thermoplastic flow behavior of the polymer can be readily analyzed with the commonly employed method of the determination of a melt-flow index (MFI). The latter method, for the present PTFE's is conveniently and reproducibly carried out according to ASTM test D1238-88, at 372° C. under a load of 10 kg, herein referred to as the melt flow index or alternatively MFI (372/10). Under these experimental conditions, and in a maximum extrudate-collection time of 1 hr, conventional ultra-high molecular weight PTFE grades have an MFI of zero. Preferably, the PTFE grades according to the present invention have a non-zero MFI (372/10) in a maximum extrudate-collection time of 1 hr. More preferably, the PTFE's are characterized by an MFI (372/10) of at least 0.1 g/10 min, for instance at least 0.2 g/10 min, at least 0.4 g/10 min, at least 0.6 g/10 min, at least 0.8 g/10 min, or at least 1.0 g/10 min. The maximum value of the melt-flow index of the PTFE grades used in the present invention depends on the particular end product and processing technique. Preferably the MFI is below 100 g/10 min, such as below 75 g/10 min, below below 45 g/10 min, below 30 g/10 min, below 15 g/10 min, below 7.5 g/10 min, below 5 g/10 min, or below 2.5 g/10 min.

The crystallinity of the poly(tetrafluoroethylene)s according to the present invention is preferably relatively low (when in unoriented form), which is beneficial for the toughness of products fabricated thereof. This degree of crystallinity is conveniently determined by differential scanning calorimetry (DSC) according to standard methods known to those skilled in the art of polymer analysis. Preferably, once-molten PTFE grades according to the present invention that are recrystallized by cooling under ambient pressure at a cooling rate of 10° C./min in unoriented form have a degree of crystallinity of below 70%, such as below 60%, below 54%, below 51%, below 49%, below 46%, or below 44%, based on an enthalpy of fusion value of 102.1 J/g for 100% crystalline PTFE (Starkweather, H. W., Jr. et al., J. Polym. Sci., Polym. Phys. Ed., Vol. 20, 751 (1982)). The crystallinity is preferably at least 10%, such as at least 20%, at least 30%, at least 35%, or at least 40%.

The PTFE grades of the present invention can be synthesized according to standard chemical methods for the polymerization of tetrafluoroethylene as described in detail in the literature (for example, W. H. Tuminello et al., Macromolecules, Vol. 21, pp. 2606-2610 (1988)) and as practiced in the art. Preferred methods for producing poly(tetrafluoroethylene)s comprising perfluoro(alkyl vinyl ether) comonomer include those described and referred to in Chapter 11 (p. 223-237) of Modern Fluoropolymers, J. Scheirs, Ed. Wiley (New York 1997). The present poly(tetrafluoroethylene)s may be postfluorinated poly(tetrafluoroethylene)s. Post-fluorination is described, for instance, on pages 228-229 of Modern Fluoropolymers, J. Scheirs, Ed. Wiley (New York 1997). Additionally, PTFE grades according to the present invention can be prepared by controlled degradation of common, high molecular weight PTFE or low co-monomer content copolymers thereof, for example by controlled thermal decomposition, electron beam, gamma- or other radiation, and the like. See, e.g., Modern Fluoropolymers, J. Scheirs, Ed. Wiley (New York), 1997.

Preferably, the present poly(tetrafluorethylene)s, after it has been in a molten state, have a tensile strength at 150° C., as determined at a strain rate of 100/min, of at least 7 MPa, for instance at least 8 MPa, at least 9 MPa, at least 12 MPa, at least 15 MPa, at least 17 MPa, at least 18.5 MPa, or even at least 20 MPa. The tensile strength (150° C.; 100/min) will generally be below 500 MPa, for instance below 250 MPa, below 100 MPa, or below 50 MPa. The tensile strength at 25° C., as determined at a strain rate of 100/min, of the present poly(tetrafluoroethylene)s is preferably at least 15 MPa, for instance at least 17.5 MPa, at least 20 MPa, at least 25 MPa, at least 30 MPa, or at least 33 MPa. Preferably, the present poly(tetrafluorethylene)s have a strain at break at 25° C., as determined at a strain rate of 100/min, of at least 125%, such as at least 150%, at least 200%, at least 300%, at least 400%, or even at least 500%. The strain at break (25° C.; 100/min) will generally be below 5000%.

The present invention also contemplates compositions comprising the present melt-processible poly(tetrafluoroethylene) polymer, for instance compositions comprising, relative to the total weight of the composition, at least 10 wt % of the present polymer, for instance at least 20 wt %, at least 35 wt %, or at least 60 wt %. The present compositions may comprise polymer blends formed by mixing one or more of the present poly(tetrafluoroethylene)s with one or more other polymers, for instance other fluoropolymers, such as a poly(tetrafluoroethylene) having a zero melt flow index. Bimodal, trimodal or blends of even higher modality of fluoropolymers, and generally, PTFE grades with a broad molecular weight distribution, are particularly beneficial for use in processing schemes that involve elongation or shear flow, such as film blowing, melt-spinning of fibers at spin stretch factors greater than 1, extrusion through conical dies, and the like.

The present compositions may comprise additives, such as colorants, fillers reinforcing matter plasticizers, lubricants, processing aids, blowing or foaming agents, electrically conducting matter and the like (e.g., talc, glass, or minerals such as titanium dioxide, bronze, graphite, carbon, stainless steel, or molybdenum). For instance, the compositions may comprise, relative to the total weight of the composition, at least 1 vol %, such as at least 5 vol %, at least 10 vol %, or at least 25 vol %, of additives selected from the group consisting of colorants, fillers, reinforcing matter, blowing agents, foaming agents, and electrically conducting matter.

Processing

The PTFE compositions according to the present invention can be processed into useful materials, neat or compounded, single- and multi-component shapes and articles using common melt-processing methods used for thermoplastic polymers that are well known in the art. Typical examples of such methods are granulation, pelletizing, (melt-) compounding, melt-blending, injection molding, transfer-molding, melt-blowing, melt-compression molding, melt-extrusion, melt-casting, melt-spinning, blow-molding, melt-coating, melt-adhesion, welding, melt-rotation molding, dip-blow-molding, melt-impregnation, extrusion blow-molding, melt-roll coating, embossing, vacuum forming, melt-coextrusion, foaming, calendering, rolling, and the like.

Melt-processing of the PTFE compositions according to the present invention, in its most general form, comprises heating the composition to above the crystalline melting temperature of the PTFE's to yield a polymer fluid phase. Unlike standard (ultra-high molecular weight) PTFE above its crystalline melting temperature, the PTFE grades according to the present invention form homogenous melts that can be freed from voids and memory of the initial polymer particle morphology. The latter melt is shaped through common means into the desired form, and, subsequently or simultaneously, cooled to a temperature below the crystalline melting temperature of the PTFE's, yielding an object or article of good and useful mechanical properties. In one preferred embodiment, shaped PTFE melts are rapidly quenched at a cooling rate of more than 10° C./min, more preferably more than 50° C./min, to below the crystallization temperature to yield objects, such as fibers and films, of higher toughness. In processing operations involving transfer through one or more dies of melts of the PTFE such as in fiber spinning, film- and tape extrusion, and the like, in one embodiment of the present invention it is highly beneficial to employ conical dies of low entrance angle (less than 90°) as it is well established that this reduces melt-instabilities and melt fracture, and, therewith, increases the processing speed.

In another embodiment of the present invention the PTFE is crosslinked through, for example, irradiation and the like (Fuchs, B. and Scheler, U., Macromolecules 2000, vol. 33, p. 120). When crosslinked to yield branched materials, the latter may exhibit improved film-blowing characteristics, and if crosslinked to form macroscopic networks, these materials may be a rubber, or can be subsequently stretched in the melt to yield heat-shrinkable films, or may display increased resistance to creep.

Certain articles, such as, but not limited to, fibers and films made according to the present invention optionally may, subsequently, be drawn or otherwise deformed in one or more directions, embossed, and the like to further improve the physico-chemical, mechanical, barrier, optical and/or surface properties, or be otherwise post-treated (for instance, quenched, heat treated, pressure treated, and/or chemically treated). The above methods and numerous modifications thereof and other forming and shaping, and post-processing techniques are well know and commonly practiced. Those skilled in the art of processing of thermoplastic polymers are capable of selecting the appropriate melt-processing and optional post-processing technology that is most economical and appropriate for the desired end product, or product intermediate.

Products and Applications

The products contemplated according to the present invention are numerous, and cover vastly different fields of applications. This is especially true as PTFE has been approved also for food contact and for biomedical applications. Without limiting the scope and use of the present invention, some illustrative products are indicated herein. Generally speaking, the products and materials according to the present invention include most or all applications that currently are covered by standard (ultra-high molecular weight) PTFE, and many of its modified, melt-processible co-polymers. Thus, applications are envisioned, among other industries, in the wire and cable industry, the printed-circuit board industry, semi-conductor industry, the chemical processing industry, the semiconductor industry, the automotive industry, out-door products and coatings industry, the food industry, the biomedical industry, and more generally in industries and uses where any combination of high release, anti-stick, high-temperature stability, high chemical resistance, flame-resistance, anti-fouling, UV resistance, low friction, and low dielectric constant is required.

In particular, the PTFE may be used to form at least parts in articles such as, for example, is a wire (and/or wire coating), an optical fiber (and/or coating), a cable, a printed-circuit board, a semiconductor, an automotive part, an outdoor product, a food, a biomedical intermediate or product, a composite material, a melt-spun mono-or multi-filament fiber, an oriented or un-oriented fiber, a hollow, porous or dense component; a woven or non-woven fabric, a filter, a membrane, a film, a multi-layer-and/or multicomponent film, a barrier film, a container, a bag, a bottle, a rod, a liner, a vessel, a pipe, a pump, a valve, an O-ring, an expansion joint, a gasket, a heat exchanger, an injection-molded article, a see-through article, a sealable packaging, a profile, heat-shrinkable film, and/or a thermoplastically welded part. Preferred articles may include fibers, films, coatings and articles comprising the same.

Typical examples of intermediate and end-user products that can be made according to the present invention include, but are not limited to granulate, thermoplastic composites, melt-spun mono- and multi-filament fibers, oriented and not, hollow, porous and dense, single- and multi-component; fabrics, non-wovens, cloths, felts, filters, gas house filtration bags; sheets, membranes, films (thin and thick, dense and porous); containers, bags, bottles, generally simple and complex parts, rods, tubes, profiles, linings and internal components for vessels, tanks, columns, pipes, fittings, pumps and valves; O-rings, seals, gaskets, heat exchangers, hoses, expansion joints, shrinkable tubes; coatings, such as protective coatings, electrostatic coatings, cable and wire coatings, optical fiber coatings, and the like. The above products and articles may be comprised in part or in total PTFE compositions according to the present invention, or optionally include dissimilar materials, such as for example in multi-layer and multi-component films, coatings, injection molded articles, containers, pipes, profiles, and the like. Further examples include see-through, sealable and/or heat-shrinkable packaging, barrier films and caps, conformal coatings, dense tubing and linings, thin-walled and complex injection-molded parts, and the like.

### EXAMPLES

The following examples are given as particular embodiments of the invention and to demonstrate the practice and advantages thereof. The examples are given by way of illustration and are not intended to limit the specification or the claims that follow in any manner.

General Methods and Materials

Melt-Flow Index.

Values of the melt flow index (MFI) as discussed herein are determined in accordance with the ASTM Standard D1238-88 at a temperature of 372° C. and under a load of 10 kg.

Thermal Analysis.

Thermal analysis was conducted with a Netzsch differential scanning calorimeter (DSC, model 200). Samples of about 5 mg were heated at a standard rate of 10° C./min. Unless indicated otherwise, melting temperatures given herein refer to the endotherm peak temperatures of once molten (at 380° C.) and cooled (at 10° C./min) material. Crystallinities were determined from the enthalpies of fusion of the same specimen taking the value of 102.1 J/g for 100% crystalline PTFE (Starkweather, H. W., Jr. et al., J. Polym. Sci., Polym. Phys. Ed., Vol. 20, 751 (1982)).

Mechanical Data.

Tensile tests were carried out with an Instron Tensile Tester (model 4464) at various temperatures on dumbbell-shaped specimen of 12.7 mm gauge length and 2 mm width. The thickness of the samples was about 0.3 mm, unless indicated otherwise below. The drawing speed was 12.7 mm/min and 1270 mm/min, which corresponds to an initial strain rate of 1 min⁻¹ and 100 min⁻¹ respectively.

Materials.

Table I presents an overview of the various copolymers of PTFE that were used, listing the melting temperatures and the crystallinities of once molten (at 380° C.) and recrystallized material (cooling rate: 10° C./min), and MFI (372/10) values of the different grades, which include grades both outside the invention, and those according to the present invention. Also listed are a commercial standard UHMW PTFE grade (Lubriflon skived film, purchased from Angst & Pfister AG, Switzerland), and a commercial PFA grade (PFA 340, Du Pont, purchased from Dolder AG, Switzerland).

TABLE 1
Comonomer content, melting temperature, melt flow index,
and crystallinity of polymers used.

| | | Melting | | |
|---|---|---|---|---|
| | PPVE-content | Temperature | MFI(372/10) | Crystallinity |
| Sample | (wt %) | (° C.) | (g/10 min) | (%) |
| I | 0.17 | 327 | 24 | 77.6 |
| II | 0.33 | 325 | 21 | 67.1 |
| III | 0.6 | 323 | 16 | 60.7 |
| IV | 1.0 | 320 | 50 | 61.1 |
| V | 0.6 | 323 | 24 | 62.0 |
| VI | 0.65 | 322 | 11.7 | 56.0 |
| VII | 0.09 | 329 | 0.8 | 62.5 |
| VIII | 1.0 | 320 | 36 | 58.8 |
| IX | 0.26 | 326 | 0.4 | 52.3 |
| X | 2.0 | 316 | 38 | 56.9 |
| XI | 0.24 | 326 | 1.0 | 57.1 |
| XII | 0.5 | 323 | 0.2 | 55.8 |
| XIII | 0.67 | 320 | 1.1 | 48.8 |
| XIV | 0.66 | 321 | 1.1 | 41.9 |
| XV | 0.38 | 325 | 0.7 | 52.3 |
| XVI | 1.1 | 318 | 1.5 | 43.2 |
| PFA 340 | | 310 | | 31.2 |
| PTFE | | 331 | | 30.3 |
| Lubriflon | | | | |

Comparative Examples I-VIII and Examples IX-XVI:

PTFE grades I-IV (Table I), were melt-compression molded at 380° C. with a Carver press (model M, 25 T) for 5 min at 1 metric ton (t), 10 min at 4 t, and then cooled to room temperature during 4 min under 4 t into plaques of about 15×15×about 0.03 cm. The strain at break of the thus obtained films was determined to be below 50%. Further mechanical properties were not determined.

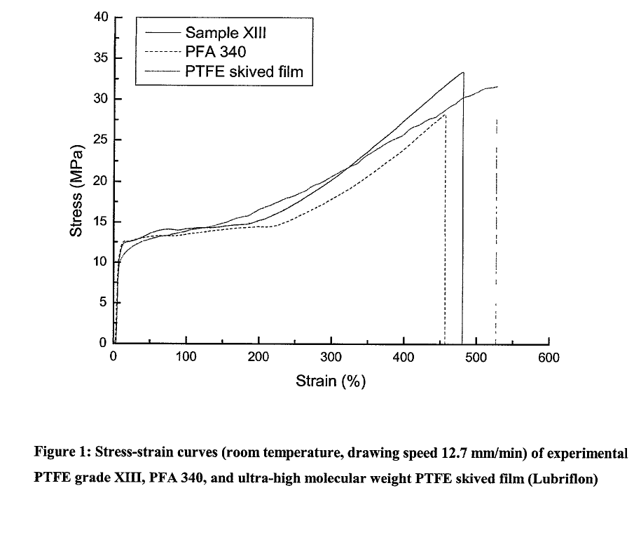

Films were then prepared with PTFE grades V-XVI, using the same procedure as with grades I-IV. The mechanical properties of the thus obtained melt-processed PTFE films were measured according to the standard method detailed above, at different strain rates and temperatures. A typical stress-strain curve is presented in FIG. 1, for comparison purposes, together with that of a sample of commercial, pre-formed/sintered and PTFE skived film of 0.40 mm thickness, and a compression molded film of PFA 340. This figure shows that the melt-processed PTFE film (grade XIII (Table I)) has the typical deformation properties of a thermoplastic, semi-crystalline polymer with a distinct yield point and strain hardening. Mechanical characteristics as a function of temperature of some of the experimental grades are summarized in Tables 2-7.

TABLE 2
Tensile strength (MPa) of selected grades (see Table 1)
as a function of temperature, measured at a drawing speed of
1270 mm/min (a strain rate of 100/min).

| | | | | | | 250° | 300° |
|---|---|---|---|---|---|---|---|
| Grade | 25° C. | 50° C. | 100° C. | 150° C. | 200° C. | C. | C. |
| V* | 11.5 | 12 | 9.5 | 7.8 | 5.6 | 4.5 | 2.6 |
| VI* | 11.5 | 10.3 | 8 | 6 | 5 | 3.8 | 2 |
| VII* | 12.5 | 9.5 | 8.5 | 6.2 | 6.2 | 3.8 | 2.7 |
| VIII* | 15 | 12 | 10 | 6.6 | 5.6 | 4 | 3.3 |
| IX | 19 | 17 | 10.3 | 9.8 | 7.5 | 5.3 | 3 |
| X | 19 | 20 | 5.5 | 12 | 8 | 5.4 | 3.9 |
| XI | 23 | 20 | 14 | 10.5 | 9.8 | 7 | 4.5 |
| XII | 24.3 | 22.5 | 16.3 | 13.5 | 11.3 | 6.3 | 4.5 |
| XIII | 27 | 29 | 22.5 | 21 | 15.5 | 10.8 | 6 |
| XIV | 32.8 | 27.8 | 20.5 | 17.9 | 14 | 10.5 | 6 |
| XV | 33 | 27 | 20 | 15.7 | 12 | 9.2 | 6.5 |
| XVI | 40 | 33 | 26 | 23 | 17.7 | 13.9 | 7.8 |
| PFA 340* | 28.5 | 23 | 18 | 16 | 10.5 | 8 | 4 |
| PTFE | 32.3 | 22 | 16 | 11 | 8 | 7 | 5 |
| Lubriflon* | | | | | | | |

*Comparative Examples

TABLE 3
Strain at break (%) of selected grades (see Table 1)
as a function of temperature, measured at a drawing speed of
1270 mm/min (a strain rate of 100/min).

| | | | | | | 250° | 300° |
|---|---|---|---|---|---|---|---|
| Grade | 25° C. | 50° C. | 100° C. | 150° C. | 200° C. | C. | C. |
| V* | 100 | 80 | 80 | 70 | 50 | 80 | 50 |
| VI* | 400 | 300 | 350 | 320 | 250 | 350 | 200 |
| VII* | 300 | 180 | 150 | 140 | 200 | 180 | 250 |
| VIII* | 60 | 200 | 100 | 100 | 50 | 80 | 50 |
| IX | 550 | 520 | 440 | 520 | 540 | 560 | 620 |
| X | 400 | 420 | 410 | 400 | 470 | 350 | 560 |
| XI | 430 | 450 | 400 | 420 | 400 | 400 | 520 |
| XII | 530 | 510 | 550 | 540 | 560 | 570 | 610 |
| XIII | 480 | 510 | 510 | 500 | 520 | 600 | 700 |
| XIV | 540 | 530 | 560 | 470 | 550 | 600 | 780 |
| XV | 520 | 530 | 500 | 500 | 550 | 560 | 700 |
| XVI | 480 | 500 | 560 | 580 | 540 | 580 | 700 |
| PFA 340* | 470 | 500 | 560 | 600 | 650 | 550 | 690 |
| PTFE | 380 | 550 | 900 | 850 | 820 | 850 | 850 |
| Lubriflon* | | | | | | | |

*Comparative Examples

TABLE 4
Yield stress (MPa) of selected grades (see Table 1)
as a function of temperature, measured at a drawing speed of
1270 mm/min (strain rate of 100/min).

| | | | | | | 250° | 300° |
|---|---|---|---|---|---|---|---|
| Grade | 25° C. | 50° C. | 100° C. | 150° C. | 200° C. | C. | C. |
| V* | 11.5 | 12.5 | 8.5 | 5.5 | 4.5 | 4 | 2 |
| VI* | 11.5 | 9.5 | 7.5 | 6 | 4.5 | 3.4 | 2 |
| VII* | 11.8 | 9.5 | 7.5 | 4.7 | 4.5 | 3.2 | 2.5 |
| VIII* | 15 | 12 | 9.5 | 5 | 4.5 | 3.5 | 3 |
| IX | 11.5 | 10 | 8 | 6 | 5.5 | 4 | 2.8 |
| X | 16 | 13.5 | 9.5 | 6 | 5.5 | 4 | 2.8 |
| XI | 13.5 | 11.5 | 7.5 | 6 | 5 | 4.5 | 3.5 |
| XII | 12.5 | 9.5 | 8 | 6.5 | 5.5 | 4 | 3 |
| XIII | 13.5 | 10.5 | 7.5 | 5 | 5 | 4.5 | 2.8 |
| XIV | 12 | 11.5 | 9 | 7.6 | 5.5 | 4.5 | 3 |
| XV | 15 | 11 | 7 | 5.5 | 5 | 4.5 | 3 |
| XVI | 16 | 12 | 7.5 | 6 | 4.5 | 4 | 2.8 |
| PFA 340* | 12.8 | 11 | 8.7 | 6 | 5 | 3.8 | 1.8 |
| PTFE | 12.5 | 8 | 6.5 | 4.3 | 3 | 2.5 | 2 |
| Lubriflon* | | | | | | | |

*Comparative Examples

TABLE 5
Tensile strength (MPa) of selected grades (see Table 1)
as a function of temperature, measured at a drawing speed of
12.7 mm/min (strain rate of 1/min).

| | | | | | | 250° | 300° |
|---|---|---|---|---|---|---|---|
| Grade | 25° C. | 50° C. | 100° C. | 150° C. | 200° C. | C. | C. |
| V* | 12.5 | 10 | 9.5 | 5.6 | 4.8 | 3 | 1.7 |
| VI* | 11.5 | 10.3 | 8 | 6 | 5 | 3.8 | 2 |
| VII* | 10.7 | 10 | 7 | 6.8 | 4.6 | 3 | 2.4 |
| VIII* | 12.5 | 11 | 9 | 6.3 | 4.7 | 3 | 1.6 |
| IX | 19 | 17 | 10.3 | 9.8 | 7.5 | 5.3 | 3 |
| X | 13 | 14 | 12.5 | 10 | 6.3 | 4.5 | 2.5 |
| XI | 15.2 | 12 | 10.5 | 10 | 6.9 | 4.5 | 3.2 |
| XII | 24.3 | 22.5 | 16.3 | 13.5 | 11.3 | 6.3 | 4.5 |
| XIII | 34 | 27 | 22 | 16 | 10.5 | 7.7 | 5.5 |
| XIV | 32.8 | 27.8 | 20.5 | 17.9 | 14 | 10.5 | 6 |
| XV | 25 | 19 | 15.5 | 13.8 | 9.5 | 7 | 5 |
| XVI | 32.5 | 25 | 23.5 | 21 | 14.5 | 13 | 7 |
| PFA 340* | 28.5 | 23 | 18 | 16 | 10.5 | 8 | 4 |
| PTFE | 32.3 | 22 | 16 | 11 | 8 | 7 | 5 |
| Lubriflon* | | | | | | | |

*Comparative Examples

TABLE 6
Strain at break (%) of selected grades (see Table 1)
as a function of temperature, measured at a drawing speed of
12.7 mm/min (strain rate of 1/min).

| | | | | | | 250° | 300° |
|---|---|---|---|---|---|---|---|
| Grade | 25° C. | 50° C. | 100° C. | 150° C. | 200° C. | C. | C. |
| V* | 50 | 55 | 30 | 22 | 20 | 15 | 10 |
| VI* | 140 | 150 | 140 | 120 | 70 | 40 | 50 |
| VII* | 60 | 60 | 60 | 70 | 60 | 30 | 30 |
| VIII* | 50 | 40 | 60 | 50 | 25 | 20 | 20 |
| IX | 420 | 350 | 340 | 360 | 320 | 450 | 490 |
| X | 180 | 300 | 330 | 340 | 350 | 260 | 320 |
| XI | 300 | 320 | 330 | 310 | 250 | 230 | 250 |
| XII | 500 | 550 | 500 | 500 | 500 | 500 | 600 |
| XIII | 470 | 470 | 430 | 430 | 500 | 580 | 750 |
| XIV | 520 | 530 | 500 | 530 | 530 | 600 | 760 |
| XV | 450 | 400 | 420 | 420 | 460 | 500 | 700 |
| XVI | 470 | 460 | 480 | 460 | 510 | 580 | 690 |
| PFA 340* | 450 | 470 | 520 | 520 | 550 | 600 | 750 |
| PTFE | 520 | 700 | 600 | 520 | 500 | 500 | 550 |
| Lubriflon* | | | | | | | |

*Comparative Examples

TABLE 7
Yield stress (MPa) of selected grades (see Table 1)
as a function of temperature, measured at a drawing speed of
12.7 mm/min (strain rate of 1/min).

| | | | | | | 250° | 300° |
|---|---|---|---|---|---|---|---|
| Grade | 25° C. | 50° C. | 100° C. | 150° C. | 200° C. | C. | C. |
| V* | 12 | 10 | 8 | 4 | 2.5 | 3 | 1 |
| VI* | 11.5 | 9.5 | 7.5 | 6 | 4.5 | 3.4 | 2 |
| VII* | 10.2 | 9 | 5.8 | 5 | 4 | 3 | 2 |
| VIII* | 11 | 10.5 | 7.8 | 5 | 4 | 3 | 1.5 |
| IX | 11.5 | 10 | 8 | 6 | 5.5 | 4 | 2.8 |
| X | 13.3 | 13 | 8.5 | 5.5 | 4.5 | 3 | 2 |
| XI | 10 | 9.5 | 6 | 5 | 4 | 3 | 2.5 |
| XII | 12.5 | 9.5 | 8 | 6.5 | 5.5 | 4 | 3 |
| XIII | 12 | 10.5 | 7.5 | 5 | 5 | 4 | 2.8 |
| XIV | 12 | 11.5 | 9 | 7.6 | 5.5 | 4.5 | 3 |
| XV | 12 | 9.5 | 7 | 5 | 5 | 4 | 2.5 |
| XVI | 12.5 | 8.5 | 7 | 6 | 4.5 | 4 | 2 |
| PFA 340* | 12.8 | 11 | 8.7 | 6 | 5 | 3.8 | 1.8 |
| PTFE | 12.5 | 8 | 6.5 | 4.3 | 3 | 2.5 | 2 |
| Lubriflon* | | | | | | | |

*Comparative Examples

PTFE grades I-XVI and ultra-high molecular weight PTFE (Lubriflon) were introduced into a laboratory, recycling twin-screw extruder (MicroCompounder, DACA Instruments), the temperature of which was kept at 380° C., and that was equipped with an exit die (entrance angle 90°) of 2 mm diameter. All grades could be extruded, except for the UHMW PTFE (viscosity too high: melt flow index of zero).

Having described specific embodiments of the present invention, it will be understood that many modifications thereof will readily be apparent to those skilled in the art, and it is intended, therefore, that this invention is limited only by the spirit and scope of the following claims.

What is claimed is:

1. A poly(tetrafluoroethylene) polymer having:
(i) a melt flow index (372° C.; 10 kg) of at least 0.1 g/10 min;
(ii) a strain at break at (25° C.; 100/min) of at least 125%;
(iii) a tensile strength (150° C.; 100/min) of at least 7 MPa;
(iv) a co-monomer content below 2.2 wt %;
(v) a peak melting temperature above 315° C.;
(vi) a crystallinity below 60%; and
(vii) one or more of the following parameters:
(a) a peak melting temperature below 320° C.;
(b) a crystallinity between 30% and 54%;
(c) a melt-flow index (372° C./10 kg) below 10 g/10 min;
(d) a co-monomer content above 1 wt %.

2. The polymer of claim 1, wherein said polymer has a peak melting temperature in the range of above 315° C. to below 320° C.

3. The polymer of claim 1, wherein said polymer has a crystallinity between 30% and 54%.

4. The polymer of claim 1, wherein said polymer has a melt-flow index (372° C./10 kg) below 10 g/10 min.

5. The polymer of claim 1, wherein said polymer has a co-monomer content above 1 wt %.

6. The polymer according to any one of claims 1-5, wherein said polymer has two or more of said parameters (a)-(d).

7. The polymer according to any one of claims 1-5, wherein said polymer has three or more of said parameters (a)-(d).

8. The polymer of claim 1, wherein said polymer has all four of said parameters (a)-(d).

9. The polymer according to any one of claims 1-8, wherein said polymer has a melt flow index (372° C.; 10 kg) of at least 0.6 g/10 min.

10. The polymer according to any one of claims 1-9, wherein said polymer has a strain at break at (25° C.; 100/min) of at least 400%.

11. The polymer according to any one of claims 1-10, wherein said polymer has a tensile strength (150° C.; 100/min) of at least 15 MPa.

12. The polymer according to any one of claims 1-11, wherein said polymer has a comonomer content between 1 and 1.4 wt %.

13. The polymer according to any one of claims 1-12, wherein said polymer has a peak melting temperature in the range of 316-319° C.

14. The polymer according to any one of claims 1-13, wherein said polymer has a crystallinity in the range of 35-44%.

15. The polymer according to any one of claims 1-13, wherein said polymer comprises a co-monomer selected from the group consisting of hexafluoropropylene, perfluoro(methyl vinyl ether), perfluoro(ethyl vinyl ether), perfluoro(propyl vinyl ether), perfluoro-(2,2-dimethyl-1,3-dioxole).

16. The polymer according to any one of claims 1-13, wherein said polymer comprises a perfluor(alkyl vinyl ether) co-monomer.

17. The polymer according to any one of claims 1-13, wherein said polymer comprises a perfluoro(propyl vinyl ether) co-monomer.

18. The polymer according to any one of claims 1-13, wherein said polymer comprises a hexafluoropropylene co-monomer.

19. A composition comprising the polymer according to any one of claims 1-18.

20. The composition of claim 19, wherein said composition comprises at least 20 wt % of said polymer.

21. The composition according to any one of claims 19-20, wherein said composition comprises at least 5 wt % of additives selected from the group consisting of colorants, fillers, reinforcing matter, blowing agents, foaming agents, and electrically conducting matter.

22. The composition according to any one of claims 19-21, wherein said composition comprises, titanium dioxide, carbon, graphite, glassfiber, molybdenum, bronze, or stainless steel.

23. A blend of two or more poly(tetrafluorethylene) polymers, at least one of said two or more poly(tetrafluorethylene) polymers being a polymer according to any one of claims 1-18.

24. An article comprising the polymer according to any one of claims 1-18.

25. The article of claim 24, wherein said article is formed at least in part by melt-processing said polymer.

26. A method comprising:
melt-processing the polymer according to any one of claims 1-18.

27. The method of claim 26, wherein said method includes injection molding, transfer-molding, melt-blowing, melt-extrusion, melt-spinning, and/or blow-molding.

28. An article obtained by the method of claim 27.
